(19) United States
(12) Patent Application Publication
(10) Pub. No.: US 2026/0118311 A1
(43) Pub. Date: Apr. 30, 2026

(54) ELECTROCHEMICAL GAS SENSOR FOR DETECTING HIGH PHOSPHINE CONCENTRATIONS

(71) Applicant: Dräger Safety AG & Co. KGaA, Lübeck (DE)

(72) Inventors: Stephan HAUPT, Lübeck (DE); Andreas NAUBER, Lübeck (DE); Rolf ECKHARDT, Lübeck (DE); Tobias REIER, Lübeck (DE); Manuel GLIECH, Lübeck (DE); Florian WÄTJEN, Lübeck (DE)

(21) Appl. No.: 18/863,060

(22) PCT Filed: Apr. 21, 2023
(86) PCT No.: PCT/DE2023/100291

§ 371 Date: Nov. 5, 2024

(30) Foreign Application Priority Data
May 6, 2022 (DE) 10 2022 111 351.5
Feb. 28, 2023 (DE) 10 2023 104 898.8

(51) Int. Cl. G01N 27/413; G01N 27/30

(52) U.S. Cl. CPC G01N 27/413; G01N 27/301; G01N 27/308

(57) ABSTRACT

The present invention pertains to an electrochemical gas sensor for gaseous hydrides, wherein the gas sensor includes at least one housing with a first working electrode and with a second working electrode arranged therein, with a counterelectrode and with a reference electrode. The first working electrode, the second working electrode, the counterelectrode and the reference electrode are in an ionically conductive contact with an electrolyte. The reference electrode is arranged between the first working electrode and the second working electrode. The present invention further comprises a measuring device for the quantitative or qualitative determination of an analyte gas and a process for the quantitative or qualitative determination of an analyte gas and a process for determining the concentration of an analyte gas, as well as the use of an electrochemical gas sensor or measuring device for determining the concentration of an analyte gas.

### CROSS REFERENCE TO RELATED APPLICATIONS

This application is a U.S. National Phase Application of International Application PCT/DE2023/100291, filed Apr. 21, 2023, and claims the benefit of priority under 35 U.S.C. § 119 of German Applications 10 2022 111 351.5 filed May 6, 2022 and 10 2023 104 898.8, filed Feb. 28, 2023, the entire contents of which are incorporated herein by reference.

### TECHNICAL FIELD

An electrochemical gas sensor for an analyte gas comprising a hydride compound, measuring device for the quantitative or qualitative determination of an analyte gas comprising a hydride compound and process for determining the concentration of an analyte gas comprising a hydride compound.

The present invention pertains to an electrochemical gas sensor for gaseous hydrides, wherein the gas sensor comprises at least one housing with a first working electrode and with a second working electrode, which working electrodes are arranged therein, with a counterelectrode and with a reference electrode. The gas sensor further comprises an electrolyte, which is in a conductive contact with the first working electrode, with the second working electrode, with the counterelectrode and with the reference electrode. The reference electrode is arranged between the first working electrode and the second working electrode. The present invention further comprises a measuring device for the quantitative or qualitative determination of an analyte gas and a process for determining the concentration of an analyte gas.

### BACKGROUND

Phosphine is used worldwide in agriculture for pest control, among other things, in grains. For example, grains are fumigated in this process, which is also called disinfestation, among other things, with phosphine (also called phosphane, monophosphane, hydrogen phosphide, PH₃). Attempts are hereby made to minimize or even prevent damage to grains, which occurs, for example, due to insect feeding damage or even due to contamination caused by insect excrements. It is absolutely necessary in this connection to reach a certain minimum concentration of phosphine in the grains in order to reach and to eliminate all the insects or pests present in the grains. It is problematic in this connection that the concentration of phosphine must not exceed a certain threshold value, because when a certain gas concentration of phosphine is exceeded, the pests or insects adopt a so-called chemical protective rigidity, beginning from which their metabolism is reduced, so that no metabolism takes place any longer and no phosphine is consequently absorbed any longer. Another known problem is that phosphine is an extremely toxic gas, which is odorless in the pure state and ignites spontaneously starting from a temperature of about 150° C. It is therefore necessary to know the concentration of the phosphine used from the viewpoint of occupational safety as well.

For workers working in process silos, for example, grain silos, there are portable and stationary gas warning devices, which are equipped, as a rule, with electrochemical gas sensors, and protect the work area or the worker from excessively high concentrations of an analyte gas, for example, phosphine. The permissible workplace concentrations in different countries vary from the single-digit ppm range to the medium ppb range.

Electrochemical gas sensors for determining the concentration of hydride gases, for example, phosphine and/or arsine, are already known from the state of the art. U.S. Pat. No. 5,997,706 A, EP 0 436 148 B1 and DE 198 32 395 C1 disclose electrochemical gas sensors for detecting hydride gases such as arsine and phosphine, containing a working electrode and a reference electrode in an electrolyte space, which is filled with an electrolyte and is closed with a gas-permeable membrane. KR 2020 0 082 563 A discloses a working electrode for use in a phosphine sensor. DE 199 39 011 C1 discloses an electrochemical gas sensor with a gas-permeable membrane, in which the working electrode is made of a diamond-like carbon and is applied as a thin layer to the gas-permeable membrane. DE 101 59 616 B4 discloses an electrochemical gas sensor for phosphine and arsine with an improved cross sensitivity.

The electrochemical gas sensors for hydride gases, which are known from the state of the art, often have the problem that in the case of the high concentrations of analyte gas, for example, phosphine and/or arsine, which concentrations are necessary for a successful disinfestation, the analyte gas is not reacted completely at the working electrode (also called measuring electrode) during the diffusion into the electrochemical gas sensor, so that the analyte gas reaches the reference electrode in the worst case scenario. This could cause a shift of the working potential of the working electrode, as a result of which the chemical reaction at the working electrode is prevented from occurring and the sensitivity of the sensor to the analyte gas is thus reduced to the extent that this gas cannot be detected any longer or the sensor sensitivity embodied in the measuring system is calculated as a false measurement result with the excessively low measured current.

Thus, there continues to be a need for electrochemical gas sensors which can be used especially for measuring and detecting analyte gases comprising a hydride compound at the concentrations necessary for the disinfestation and which can provide a high long-term stability, i.e., a reliable measurement result over a long time period, without the measurement result “collapsing” to low measured values, i.e., becoming distorted, after a certain period of use.

### SUMMARY

It is an object of the present invention, among other things, to provide an electrochemical gas sensor, which solves the problems known from the state of the art. Consequently, an electrochemical gas sensor shall be provided, which is suitable for the measurement or detection of an analyte gas comprising a hydride compound, for example, phosphine (PH₃), borane (BH₃), diborane (B₂H₆), arsine (AsH₃), SeH₂ and other hydride compounds, which has a long-term stability, without the measured signals “collapsing” or becoming inaccurate after a certain time, and which has a high long-term fumigation stability, i.e., a high long-term signal stability ideally even over a time period ranging from at least four hours to several months. In addition, one object of the present invention is to provide an electrochemical gas sensor, which can be used by the end user in a cost-effective manner, without requiring a high level of maintenance or a large number of maintenance cycles.

An It was surprisingly found that if at least a first working electrode and a second working electrode and a reference electrode arranged between the first working electrode and the second working electrode are arranged within the housing, the signal stability of an electrochemical gas sensor according to the present invention could be achieved even at high concentrations of the analyte gas equaling up to 1,000 ppm and higher, without the measured signal of the electrochemical gas sensor according to the present invention “collapsing,” i.e., that the measured signal remains stable even at the high analyte gas concentrations necessary for the disinfestation.

An electrochemical gas sensor for an analyte gas comprising at least one hydride compound is proposed according to the present invention, the gas sensor comprising at least
a) a housing, wherein the following components are also arranged within the housing:
b) at least a first working electrode and a second working electrode;
c) a counterelectrode;
d) a reference electrode, and
e) an electrolyte, which is in a conductive contact with the first working electrode, with the second working electrode, with the counterelectrode and with the reference electrode, wherein the reference electrode is arranged between the first working electrode and the second working electrode.

Further, a measuring device is proposed for the quantitative or qualitative determination of an analyte gas, the measuring device having an electrochemical gas sensor according to the present invention.

Further, a use of an electrochemical gas sensor according to the present invention and/or of a measuring device according to the present invention for determining the concentration of an analyte gas is disclosed.

In addition, the present invention pertains to a process for determining the concentration of an analyte gas comprising a hydride compound with an electrochemical gas sensor,

The analyte gas is a gas which is admitted or can be admitted to the electrochemical gas sensor or the concentration of which is determined. The analyte gas usually diffuses together with air from the ambient atmosphere (ambient air) to the gas sensor according to the present invention, or it is admitted to the electrochemical gas sensor according to the present invention. The analyte gas comprises one or more hydride gases or one or more gaseous hydride compounds or vapors thereof, preferably phosphine (PH₃), borane (BH₃), diborane (B₂H₆), arsine (AsH₃) and/or saline (SeH₂). The electrochemical gas sensor according to the present invention is preferably used for phosphine and/or arsine as the analyte gas, and especially preferably for phosphine. Said hydride gases or said hydride compounds are also called non-metal hydrides or non-metal hydride compounds or metalloid hydrides or metalloid hydride compounds in the sense of the present invention. The analyte gas is typically contained in the ambient atmosphere of the gas sensor, but it may also be fed to the gas sensor separately, e.g., in well-defined doses, batchwise, etc.

The housing of the electrochemical gas sensor defines said electrochemical gas sensor to the outside. The housing is usually in contact with the ambient atmosphere outwards and forms a receptacle on the inside for the electrodes, such as the first working electrode, the second working electrode, the counterelectrode and the reference electrode, as well as for the electrolyte. The housing may be manufactured from different materials typical for the use of electrochemical gas sensors. These include, for example, plastics, e.g., polyethylene (PE), polypropylene (PP), perfluoroalkoxy polymers (PFA), fluoroethylene propylene (FEP) or polytetrafluoroethylene (Teflon, PTFE). The housing of the electrochemical gas sensor preferably has, furthermore, an electrolyte reservoir for receiving the electrolyte, configured, for example, as a compensating volume.

The first working electrode and/or the second working electrode comprise in a preferred embodiment an electrode material, which is selected from the group consisting of or comprising gold, platinum, rhodium, ruthenium and iridium, and preferably gold. The first working electrode and the second working electrode may also be manufactured from or comprise different electrode materials as well as identical electrode materials. In a preferred embodiment, both the first working electrode and the second working electrode are each gold electrodes, i.e., both the first working electrode and the second working electrode preferably comprise gold or consist of gold.

The first working electrode and the second working electrode may be used each both with and without a carrier material or an electrode membrane in an electrochemical gas sensor according to the present invention. In another embodiment, the first working electrode and/or the second working electrode may be arranged at or on a polymer nonwoven or glass nonwoven. A polymer nonwoven may be, for example, a hydrophilic polyolefin nonwoven or a perfluorinated nonwoven, e.g., a hydrophilized PTFE nonwoven (perfluorinated tetrafluoroethylene nonwoven). The first working electrode may be arranged in one embodiment on a gas-permeable and preferably electrolyte-impermeable blocking layer. The first working electrode may be arranged according to the present invention such that the analyte gas reaches the first working electrode directly during its diffusion into the electrochemical gas sensor.

The reference electrode is arranged according to the present invention between the first working electrode and the second working electrode. The reference electrode preferably comprises an electrode material which is selected from the group consisting of or comprising ruthenium oxide (RuO₂), carbon nanotubes, nitrogen-doped carbon nanotubes, graphene, diamond-like carbon and reduced graphene oxide. The reference electrode preferably also comprises or consists of an electrode material which is selected from the group comprising ruthenium oxide, carbon nanotubes and nitrogen-doped carbon nanotubes. The reference electrode especially preferably comprises ruthenium oxide and/or nitrogen-doped carbon nanotubes or consists of same. It was surprisingly found that a reference electrode comprising ruthenium oxide and/or nitrogen-doped carbon nanotubes operates in an especially robust manner in the electrochemical gas sensor according to the present invention, i.e., that the measured signal is not distorted over several hours even at high concentrations of the analyte gas and during prolonged exposure to the analyte gas. The inventors surprisingly found that the electrical voltage present at the reference electrode is especially stable in case of the use of hydride compounds or of hydride gases, especially when phosphine is used as the analyte gas.

The housing of an electrochemical gas sensor according to the present invention is created in one embodiment such that the analyte gas can diffuse through the housing into the electrochemical gas sensor. In a preferred embodiment, the housing has an opening or a diffusion membrane for the gas exchange with the surrounding area and an electrolyte-filled reaction space, in which the electrodes (first working electrode and second working electrode, counterelectrode as well as reference electrode) are arranged. The analyte gas diffuses in this embodiment, for example, through the diffusion membrane and optionally through a working electrode membrane into the reaction space of the gas sensor and farther to the first working electrode. A direct reaction takes place at the first working electrode, and a reverse reaction takes place at the counterelectrode.

In a preferred electrochemical gas sensor, the analyte gas diffuses in one embodiment from the ambient air through a preferably electrolyte-impermeable and also preferably hydrophobic (water-repellent) diffusion membrane into the electrochemical gas sensor and reaches the three-phase boundary, which is formed by the first working electrode, the electrolyte as well as the analyte gas. The analyte gas finally reacts at the working electrode (direct reaction), and the reaction products formed at the counterelectrode (reverse reaction) will finally enter the electrolyte again. Water is formed in the process at the counterelectrode. Without being bound to the theory, the inventors assume that the following reactions take place at the first working electrode and at the counterelectrode when phosphine is used as the analyte gas:

Oxidation of phosphine into phosphate at the first working electrode (cathode) according to the following equation:

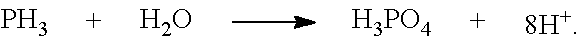

Reduction of oxygen to 2 O₂₋ at the counterelectrode (anode) according to the following equation:

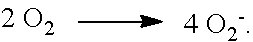

The following overall reaction, taking place within the electrochemical gas sensor according to the present invention, arises from the above two reactions called half-cell reactions:

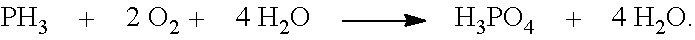

Without being bound to the theory, phosphine is thus oxidized to phosphoric acid at the first working electrode and oxygen is reduced at the counterelectrode according to the above equation when phosphine is admitted as an analyte gas to the electrochemical gas sensor according to the present invention.

In another preferred embodiment, the housing has both a first diffusion membrane and a second diffusion membrane. This has proved to be especially advantageous because, for example, the electrolyte may be hygroscopic, which may lead to an increase in the volume of the electrolyte, because the electrolyte can absorb, for example, water contained in the ambient air. It may therefore be advantageous to arrange at least one second diffusion membrane in the housing, through which membrane a pressure equalization with the surrounding area is made possible. The second diffusion membrane may, in principle, be arranged above all within the housing. During the inward diffusion of the analyte gas through the first diffusion membrane, the analyte gas reaches the three-phase boundary between the first working electrode, the analyte gas and the electrolyte. When phosphine is used as the analyte gas, the above-described direct reaction, namely, the oxidation of phosphine to phosphoric acid, takes place at the first working electrode.

It is especially preferred for the electrochemical gas sensor to have a first diffusion membrane and a second diffusion membrane located essentially opposite the electrochemical gas sensor. The second diffusion membrane is especially advantageous because products formed within the electrochemical gas sensor, for example, gases or else even water, can diffuse through the second diffusion membrane acting as a gas outlet into the surrounding area again. A second opening in the form of a second diffusion membrane is likewise advantageous, because an overpressure or vacuum may develop within the electrochemical gas sensor, and this overpressure or vacuum can likewise be dissipated through the diffusion membrane. Overpressure or vacuum may develop, for example, due to changes in the ambient temperature.

Analyte gas may also diffuse into the electrochemical gas sensor through the second diffusion membrane, analogously to the first diffusion membrane, at the high gas concentrations necessary for the disinfestation. The reference electrode is arranged according to the present invention between the first working electrode and the second working electrode. In this embodiment, the analyte gas reaches the second working electrode during the diffusion into the electrochemical gas sensor through the second diffusion membrane and through an optional working electrode membrane and is oxidized at the second working electrode analogously to the first working electrode. Due to the claimed arrangement of the reference electrode between the first working electrode and the second working electrode, it was surprisingly found that the signal stability of the electrochemical gas sensor according to the present invention does not “collapse” even at the high gas concentrations of analyte gas necessary for the disinfestation, i.e., that the measured signal is not distorted even at the high concentrations. The second working electrode acts here as a kind of protective electrode, which is set up to oxidize all the analyte gas having diffused into the electrochemical gas sensor, which analyte gas was not oxidized already at the first working electrode. It is ensured by the claimed arrangement of the reference electrode between the first working electrode and the second working electrode that little or ideally no analyte gas will reach the reference electrode. It is known to the person skilled in the art that the measured signal of the electrochemical gas sensor is distorted when analyte gas reaches the reference electrode through the electrolyte.

The counterelectrode is preferably arranged within the electrochemical gas sensor such that it can come easily into contact with the ambient atmosphere, in which oxygen is also present in addition to the analyte gas, preferably via a diffusion membrane. The material for the counterelectrode is selected to be such that oxygen can be reduced at this counterelectrode according to the above equation in the electrochemical gas sensor according to the present invention. All the electrode materials known to the person skilled in the art may be considered for use for the counterelectrode. The inventors found that the electrode material for the counterelectrode is not critical. In a preferred embodiment, in which the housing of the electrochemical gas sensor has a first diffusion membrane and a second diffusion membrane located essentially opposite to it, the counterelectrode is arranged under the second diffusion membrane (i.e., farther outside when viewed in a longitudinal direction or gas inlet direction of the gas sensor than the second diffusion membrane), especially preferably between the second diffusion membrane and the second working electrode. The reverse reaction, i.e., the reduction of oxygen into 2 O₂₋, which reverse reaction is necessary for the stability of the electrochemical gas sensor according to the present invention, can take place due to this arrangement. The arrangement of the counterelectrode under a diffusion membrane, preferably under a second diffusion membrane, ensures that a continuous gas exchange can take place between the ambient atmosphere and the counterelectrode. As a result, the reduction of oxygen contained in the ambient atmosphere, which takes place at the counterelectrode, can take place.

In another preferred embodiment, the reference electrode is enclosed at least partially by a film, which is preferably impermeable to the analyte gas. As a result, contacting between the analyte gas and the reference electrode is additionally prevented or is made difficult, which in turn leads to a further improvement of the signal stability. The reference electrode is especially preferably enclosed at least partially by a polyvinylidene fluoride film (PVDF film). An electrochemical gas sensor having a reference electrode comprising a nitrogen-doped carbon nanotube enclosed by a PVDF film or an RuO₂ reference electrode enclosed by a PVDF film is especially preferably provided. Enclosed or wrapped-around or enveloped means that the reference electrode is ideally shielded from the analyte gas, but it continues to be in contact with the electrolyte in an ionically conductive manner.

In a preferred electrochemical gas sensor, the housing has two diffusion membranes arranged essentially opposite each other. Analyte gas diffuses in this preferred electrochemical gas sensor through the first diffusion membrane and optionally through a working electrode membrane into the electrolyte of the electrochemical gas sensor. The analyte gas is oxidized at least partially at the three-phase boundary consisting of analyte gas, a first working electrode and electrolyte. First the first working electrode, then the reference electrode, then the second working electrode, and then the counterelectrode are arranged between the first diffusion membrane and the second diffusion membrane in the diffusion direction of the analyte gas from the first diffusion membrane in the direction of the second diffusion membrane. One or more respective separators may be arranged in another preferred embodiment between the first working electrode and the reference electrode and/or between the reference electrode and the second working electrode and/or between the second working electrode and the counterelectrode. The separators prevent the development of a short-circuit between the electrodes, i.e., between the first working electrode and the second working electrode, the reference electrode and the counterelectrode. At least one respective separator is especially preferably located between all the electrodes mentioned. The separators are, for example, glass nonwovens or consist of some other similar material. These separators have an electrolyte-permeable configuration and absorb the electrolyte and thus form the carrier for an electrolyte bridge, so that ions can move between the individual electrodes.

It is possible in another preferred embodiment that the second working electrode comprises two or more short-circuited individual electrodes. The effective surface of the second working electrode can be enlarged in this manner, which leads in turn to analyte gas diffusing into the electrochemical gas sensor to be oxidized more rapidly. As a result, it is likewise possible to reduce the probability of analyte gas diffusing into the electrochemical gas sensor reaching the reference electrode, which is undesirable, because this leads to a “collapsing” of the measured signal and the measured signal is distorted thereby, as was explained in the introduction.

Especially lithium chloride, ionic liquids, sulfuric acid and/or an ethylene carbonate/propylene carbonate solution (ECPC solution) with a conductive salt, for example, tetrabutyl ammonium tosylate or mesylate, are used as possible electrolytes in an electrochemical gas sensor according to the present invention. Ionic liquids (IL) are defined, in principle, as highly concentrated, aqueous salt solutions or also salts in a liquid state (so-called molten salts, MS), which consist mainly of positively or negatively charged ions. Sulfuric acid (H₂SO₄) is used preferably.

The reference electrode is arranged according to the present invention between the first working electrode and the second working electrode. In an especially preferred electrochemical gas sensor, in which the first working electrode, then the reference electrode, then the second working electrode, then the counterelectrode are arranged in the diffusion direction from a first diffusion membrane in the direction of the second diffusion membrane located essentially opposite, the second working electrode has a device that makes it possible for the electrolyte to be able to move between the counterelectrode and the reference electrode. In other words, the device makes it possible for the electrolyte to flow through. In an especially preferred embodiment, the second working electrode has an opening and/or a secant, which is configured to enable the electrolyte to flow through the opening and/or the secant. The opening and/or the secant is formed even more preferably in the second working electrode such that the diffusion path between the second working electrode and the reference electrode is as long as possible. It is thus preferred that the reference electrode is arranged at the greatest distance possible from the opening and/or from the secant. As a result, the diffusion path of the analyte gas present in the electrolyte is additionally increased from the second working electrode in the direction of the reference electrode, which brings about an additional signal stability, especially at very high gas concentrations of analyte gas, which are necessary for the disinfestation.

The electrochemical gas sensor may have additional elements, such as a coupling unit, which may be set up to connect electrically the electrodes located within the electrochemical gas sensor, i.e., the first working electrode, the second working electrode, the reference electrode and the counterelectrode and additional, optional electrodes to an electrical circuit, such as a potentiostat or a galvanostat. The coupling unit may have one or more contact pins, which may be in an electrically conductive connection with the electrodes, for example, via platinum wires.

In another embodiment, the electrochemical gas sensor according to the present invention comprises the analyte gas, the analyte gas being dissolved especially in the electrolyte.

The present invention further comprises a measuring device for the quantitative or qualitative determination of an analyte gas, which comprises a hydride compound. The measuring device according to the present invention comprises in a preferred embodiment an analysis unit, which measures an electrical current, which flows between the first working electrode and the counterelectrode when an analyte gas is admitted. The concentration of the analyte gas can thus be determined on the basis of the measured current between the first working electrode and the counterelectrode.

The present invention comprises, furthermore, a process for determining the concentration of an analyte gas comprising a hydride compound. The process according to the present invention comprises at least the following steps:
i. admission of the analyte gas into an electrochemical gas sensor, wherein the electrochemical gas sensor comprises at least a first working electrode, a second working electrode, a counterelectrode, a reference electrode arranged between the first working electrode and the second working electrode, and an electrolyte, which is in conductive contact with the first working electrode, with the second working electrode, with the counterelectrode and with the reference electrode;
ii. application of an electrical voltage between the first working electrode and the reference electrode;
iii. application of an electrical voltage between the second working electrode and the reference electrode;
iv. at least partial oxidation of the analyte gas at the first working electrode, wherein at least one reaction product migrates to the counterelectrode;
v. at least partial reduction of oxygen at the counterelectrode; and
vi. measurement of the current flowing between the first working electrode and the counterelectrode.

The analyte gas is admitted to an electrochemical gas sensor in the process according to the present invention. The electrochemical gas sensor comprises at least a first working electrode, a second working electrode, a counterelectrode, a reference electrode arranged between the first working electrode and the second working electrode, and an electrolyte, which is in conductive contact with the first working electrode, with the second working electrode, with the counterelectrode and with the reference electrode. The analyte gas comprises at least one hydride compound. An electrical voltage is applied, especially with a potentiostat, between the first working electrode and the reference electrode as well as between the second working electrode and the reference electrode. The application of the voltage between the first working electrode and the reference electrode (ii.) and the application of the voltage between the second working electrode and the reference electrode (iii.) take place preferably simultaneously, i.e., in a concentrated manner.

The voltage between the first working electrode and the reference electrode as well as the voltage between the second working electrode and the reference electrode are preferably equal. The analyte gas diffusing into the electrochemical gas sensor is oxidized at least partially at the first working electrode. When phosphine is admitted as the analyte gas to the electrochemical gas sensor, the phosphine is oxidized into phosphoric acid. Oxygen is reduced at the counterelectrode. The current flowing between the first working electrode and the counterelectrode during this reaction is measured. The current between the first working electrode and the counterelectrode is proportional to the reaction of the analyte gas at the first working electrode.

At the high gas concentrations of analyte gas that are necessary for the disinfestation, the analyte gas, which is not reacted at the first working electrode, is oxidized at the second working electrode. Analyte gas is prevented hereby from diffusing to the reference electrode, which would lead to a distortion of the measurement results. The current flowing in this case between the second working electrode and the counterelectrode is not preferably measured. This means, in other words, that the concentration of the analyte gas is determined exclusively by the flow of current between the first working electrode and the counterelectrode. The second working electrode acts especially as a kind of protective electrode, which is set up to react analyte gas, which was already oxidized at the first working electrode, so that no analyte gas can diffuse to the reference electrode.

The electrochemical gas sensor according to the present invention or the measuring device according to the present invention can be used to determine the concentration of an analyte gas comprising a hydride compound.

The advantages of the electrochemical gas sensor according to the present invention as well as the possible configuration thereof will be shown below on the basis of the following figure. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a gas sensor.

### DESCRIPTION OF PREFERRED EMBODIMENTS

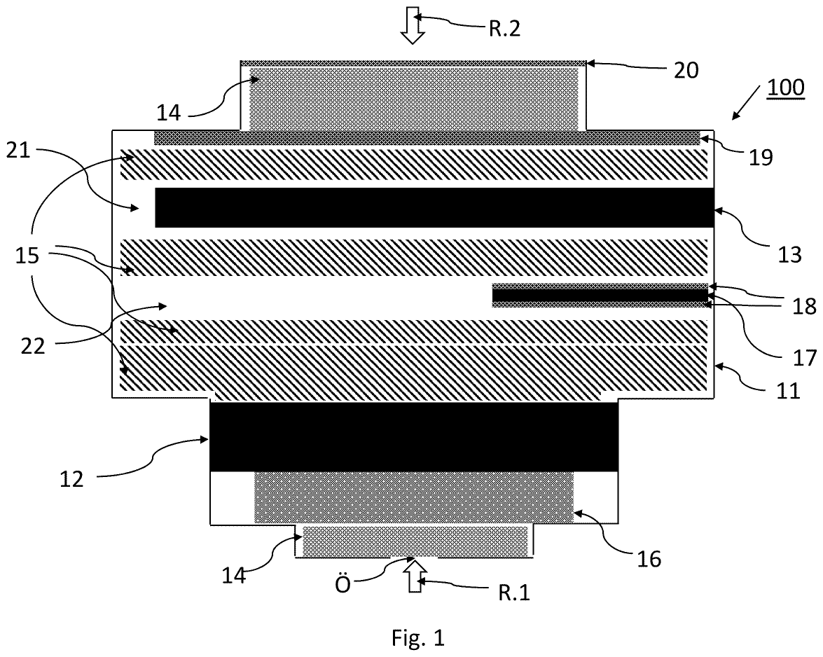

FIG. 1 shows a cross section through an electrochemical gas sensor according to the present invention with the electrodes located within the housing.

FIG. 1 shows a cross section of an electrochemical gas sensor 100 according to the present invention. The gas sensor 100 comprises a housing 11, a first working electrode 12, a second working electrode 13, a counterelectrode 19 and a reference electrode 17. The reference electrode 17 is enclosed with a gas-impermeable film 18. Enclosed or wrapped-around or enveloped means that the reference electrode is ideally shielded from the analyte gas, but it continues to be enclosed with the electrolyte in an ionically conductive manner. The reference electrode 17 is arranged between the first working electrode 12 and the second working electrode 13. Respective electrolyte-permeable separating layers (separators) 15 are arranged between the first working electrode 12 and the reference electrode 17. These separators 15 prevent the development of electrical short-circuits between the electrodes 12, 17, 13 and 19. Analyte gas diffusing into the electrochemical gas sensor 100 enters the electrochemical gas sensor 100 from below through the opening Ö in direction R.1. After passing through the gas-permeable support membrane 14 and the gas-permeable blocking layer 16, the analyte gas, dissolved in the electrolyte 22, reaches the first working electrode 12. A chemical reaction takes place at this [first working electrode]. When phosphine enters as an analyte gas, phosphine is oxidized into phosphoric acid at the first working electrode 12. A voltage (not shown) is present between the working electrode 12 and the reference electrode 17. An electrical current flows between the first working electrode 12 and the counterelectrode 19 during the oxidation of phosphine into phosphoric acid at the first working electrode 12. The concentration of the analyte gas can be determined on the basis of the flow of current between the first working electrode 12 and the counterelectrode 19 by means of an analysis unit (not shown). A voltage (not shown) is likewise present between the second working electrode 13 and the reference electrode 17. The second working electrode 13 has an opening or secant 21. The opening or secant 21 is configured for the electrolyte 22 within the electrochemical gas sensor 100 to connect the electrodes 12, 17, 13 and 19 to one another in an ionically conductive manner. An additional support membrane 14 as well as a cover 20 are located above the counterelectrode 19 at the upper end of the electrochemical gas sensor 100. The cover 20 is gas-permeable and is used, among other things, for pressure equalization. The electrolyte 22 located within the electrochemical gas sensor 100 is hygroscopic, i.e., it absorbs water from the ambient atmosphere of the electrochemical gas sensor. In order to avoid an overpressure, which would lead to the escape of electrolyte 22 from the electrochemical gas sensor 100, within the electrochemical gas sensor 100, the upper gas-permeable support membrane 14 and the cover 20 are used for pressure equalization. At the high gas concentration of analyte gas of up to 1,000 ppm or higher, which is necessary for the disinfestation, the analyte gas enters the electrochemical gas sensor 100 from the top, as is indicated by R.2. The analyte gas diffusing into the electrochemical gas sensor 100 from direction R.2 is oxidized at the second working electrode 13. In case phosphine is measured as the analyte gas, phosphine is oxidized into phosphoric acid at the second working electrode 13. Analyte gas diffusing from the top into the electrochemical gas sensor 100 is prevented from reaching the reference electrode 17 by the claimed arrangement of the second working electrode 13 at the upper end of the electrochemical gas sensor 100. No electrolyte 22 is present below the first working electrode 12 as well as above the counterelectrode 19.

While specific embodiments of the invention have been shown and described in detail to illustrate the application of the principles of the invention, it will be understood that the invention may be embodied otherwise without departing from such principles.

1. An electrochemical gas sensor for an analyte gas comprising a hydride compound, wherein the gas sensor comprises:
a housing:
at least a first working electrode and a second working electrode,
a counterelectrode,
a reference electrode, and
an electrolyte, wherein at least the first working electrode, the second working electrode, the counterelectrode, the reference electrode, and the electrolyte are arranged within the housing, wherein the electrolyte is in conductive contact with the first working electrode, with the second working electrode, with the counterelectrode and with the reference electrode; and wherein the reference electrode is arranged between the first working electrode and the second working electrode.

2. An electrochemical gas sensor in accordance with claim 1, further comprising a separator, wherein the separator is arranged between the first working electrode and the reference electrode, or between the second working electrode and the reference electrode, or between the first working electrode and the reference electrode and between the second working electrode and the reference electrode.

3. An electrochemical gas sensor in accordance with claim 1, wherein the counterelectrode is arranged between the second working electrode and the housing.

4. An electrochemical gas sensor in accordance with claim 1, wherein the sensor is configured for phosphine, borane, diborane, arsine, and SeH₂ as an analyte gas.

5. An electrochemical gas sensor in accordance with claim 1, wherein the first working electrode and/or the second working electrode comprise an electrode material selected from the group comprising gold, platinum, rhodium, ruthenium and iridium.

6. An electrochemical gas sensor in accordance with claim 1, wherein the reference electrode comprises an electrode material selected from the group comprising ruthenium oxide, carbon nanotubes, nitrogen-doped carbon nanotubes, graphene, diamond-like carbon and reduced graphene oxide.

7. An electrochemical gas sensor in accordance with claim 1, wherein the housing has at least a first diffusion membrane and a second diffusion membrane.

8. An electrochemical gas sensor in accordance with claim 7, wherein in a state suitable for use, the analyte gas diffuses at least partially through the first diffusion membrane in a direction of the second diffusion membrane, wherein the second diffusion membrane is arranged essentially opposite the first diffusion membrane, wherein first the first working electrode, then the reference electrode, then the second working electrode and then the counterelectrode are arranged in the direction from the first diffusion membrane to the second diffusion membrane, and/or in the state suitable for use, the analyte gas diffuses at least partially through the second diffusion membrane in a direction of the first diffusion membrane, wherein the second diffusion membrane is arranged essentially opposite the first diffusion membrane, wherein the analyte gas comes at least partially into contact at first with the counterelectrode and then with the second working electrode.

9. An electrochemical gas sensor in accordance with claim 1, wherein the second working electrode comprises a plurality of individual electrodes.

10. An electrochemical gas sensor in accordance with claim 1, wherein the electrolyte is selected from one or more members of the group comprising lithium chloride, ionic liquids, sulfuric acid and ECPC tetrabutyl ammonium tosylate or mesylate.

11. An electrochemical gas sensor in accordance with claim 1, wherein the second working electrode has an opening and/or a region, which is configured to enable the electrolyte to flow through the second working electrode.

12. An electrochemical gas sensor in accordance with claim 1, further comprising a film, wherein the reference electrode is enclosed at least partially by the film.

13. An electrochemical gas sensor in accordance with claim 1, further comprising the analyte gas present in the electrolyte.

14. An measuring device for a quantitative or qualitative determination of an analyte gas comprising a hydride compound, the measuring device comprising an electrochemical gas sensor in accordance with claim 1.

15. A process for determining a concentration of an analyte gas comprising a hydride compound, wherein the process comprises the steps of:
admitting the analyte gas to an electrochemical gas sensor, wherein the electrochemical gas sensor comprises at least a first working electrode, a second working electrode, a counterelectrode, a reference electrode arranged between the first working electrode and the second working electrode and an electrolyte, which is in conductive contact with the first working electrode, with the second working electrode, with the counterelectrode and with the reference electrode;
applying an electrical voltage between the first working electrode and the reference electrode;
applying an electrical voltage between the second working electrode and the reference electrode;
at least partial oxidation of partially oxidizing the analyte gas at the first working electrode,
wherein at least one reaction product migrates to the counterelectrode,
at least partially reducing oxygen at the counterelectrode, and
measuring of the current flowing between the first working electrode and the counterelectrode.

16. The process in accordance with claim 15, wherein the electrochemical gas sensor comprises a housing, wherein the at least a first working electrode and the second working electrode, the counterelectrode, the reference electrode, and the electrolyte are arranged within the housing.

17. An electrochemical gas sensor in accordance with claim 2, wherein the separator is arranged between the first working electrode and the reference electrode and between the second working electrode and the reference electrode.

18. An electrochemical gas sensor in accordance with claim 3, further comprising a separator wherein the separator is arranged between the counterelectrode and the second working electrode.

19. An electrochemical gas sensor in accordance with claim 7, wherein the counterelectrode is arranged adjacent to the second diffusion membrane.

20. An electrochemical gas sensor in accordance with claim 12, wherein the film is gas-permeable for the analyte gas and comprise a polyvinylidene fluoride film.
